(19) United States
(12) Patent Application Publication
(10) Pub. No.: US 2008/0158905 A1
(43) Pub. Date: Jul. 3, 2008

(54) OPTICAL FIBER AND THE MANUFACTURING METHOD THEREOF

(75) Inventors: Chia-Cheng Chuang, Tainan City (TW); Chung-Hsin Hsiao, Chiayi County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsinchu (TW)

(21) Appl. No.: 11/759,826

(22) Filed: Jun. 7, 2007

(30) Foreign Application Priority Data
Dec. 29, 2006 (TW) 095149725

(51) Int. Cl. F21V 8/00; C03C 25/00; G02B 6/02

(52) U.S. Cl. 362/581; 385/123; 65/392

(57) ABSTRACT

An optical fiber is disclosed, which is comprised of: a core, having a plurality of microstructures formed thereon; and a cladding layer, surrounding the core. In a preferred embodiment, as light is transmitting along the axis of the aforesaid optical fiber and strikes on the plural microstructures, it is scattered and reflected out of the optical fiber through a side wall thereof so as to achieve a side-emitting effect. As the microstructures are formed inside the core of the aforesaid optical fiber, not only they are prevented from being damaged by normal usage, contacting to adhesive directly, but also they can lower the risk of the optical fiber being snapped/deformed while the optical fiber is subjecting to an external force and bended. In addition, by controlling the shape, quantity, size, distribution density and location of the microstructure, the brightness of the side-emitting optical fiber can be adjusted correspondingly.

### FIELD OF THE INVENTION

The present invention relates to an improved optical fiber and the manufacturing method thereof, and more particularly, to an optical fiber having microstructures formed therein for blocking and scattering light traveling along its length and thus directing the light to emit radially from side walls of the optical fiber, in that each microstructures is a simple structure and can be formed inside the optical fiber by a simple manufacturing method without damaging the surface of the optical fiber, by which not only the risk of the optical fiber being snapped/deformed while the optical fiber is subjecting to an external force and bended is reduced, but also the light efficiency as well as the light uniformity of the optical fiber are improved.

### BACKGROUND OF THE INVENTION

An optical fiber (or fiber optic) is a glass or plastic fiber designed to guide light along its length by total internal reflection, which is primarily composed of a core wrapped by a caldding layer. Optical fibers are widely used in all kind of fiber-optic communications, which permits digital data transmission over longer distances and at higher data rates than electronic communication as it is comparatively less expensive, thinner and lighter, and having less signal degradation, and so on.

Fibers are also widely used in illumination applications. They are used as light guides in medical and other applications where bright light needs to be shone on a target without a clear line-of-sight path. In some buildings, optical fibers are used to route sunlight from the roof to other parts of the building. Optical fiber illumination is also used for decorative applications, including signs, art, and artificial Christmas trees. It is noted that, by applying optical fibers in a illumination device, the number of light sources, i.e. fluorescent tubes for example, can be reduced and thus the light source utilization efficient is enhanced. Therefore, more and more illumination devices, each comprising a plurality of optical fibers, are being adapted as backlight modules. Normally the light entering from one end of an optical fiber passes out the other end thereof after a certain amount of loss takes place. It is known that instead of increasing the brightness of light sources used in one such backlight module, the brightness of the backlight module can be increased by adopting optical fibers of high transparency so as to ensure a low light loss during the transmission. However, if the surface of the optical fiber is disrupted as by scratching or otherwise deformed as by bending the optical fiber at a plurality of discrete locations along its length such that the angle of bend approximately exceeds the angle of internal reflection, light will be emitted at these locations.

Please refer to FIG. 1, which shows a fiber optic light emitting panel, disclosed in U.S. Pat. No. 4,885,663, entitled “FIBER OPTIC LIGHT EMITTING PANEL AND METHOD OF MAKING SAME”. As seen in FIG. 3, a plurality of optical fibers 5 are woven or plaited together to form a sheet or a mat. Light is encouraged to leave each fiber through its side wall by the relatively sharp bends imposed upon the fiber by the act of weaving/platting the material. A portion of the light incident upon each bend exceeds the critical angle for internal reflection and escapes from the fiber. In addition, a coating 18 used is a clear epoxy which changes the attenuation a predetermined amount. Also, a lenticular or prismatic film 1 is desirably mounted on the front of the emitter surface of the light emitting panel to shift the angular emission of light. With the coating 18 and the lenticular, the light output can be made relatively uniform over substantially the entire light emitting surface. However, although the weaving/platting operation is not necessary causing breakages to the optical fiber 5, the bending of each optical fiber 5 by the weaving/platting operation can not be controlled at will so that light emitting uniformity is not satisfactory, not to mention that its manufacturing cost is relatively higher as its structure is more complicated. Furthermore, the light emitting panel, by its very nature, is only marginally flexible since the woven plait of the optical fibers 5 may be deformed and thus change the bending degree of each sharp bend when the light emitting panel is bended, thereby affecting its light emitting direction and optical efficiency.

Please refer to FIG. 2, which shows a cross section of a backlighting panel, disclosed in U.S. Pat. No. 5,226,105, entitled “FIBER OPTIC BACKLIGHTING PANEL AND DOT PROCESS FOR MAKING SAME”. As seen in FIG. 2, the fiber optic backlighting panel having two layers of optical fibers 24 and 24a arranged adjacent to each other. The optical fibers are selectively terminated at the different locations by forming holes through the layer of optical fibers with a laser, so that light transmitted along the length of each optical fiber can be emitted therefrom. However, as there is no reflective means being used for reflecting light beamed in each optical fiber out of its dotted hole, it can not provide satisfactory illumination. In order to improve the foregoing shortcoming, a bubble-like formations in the foam 60 is applied upon the two layers of optical fibers 24 and 24a for scattering the light, causing it to diffuse so as to provide uniform illumination or glow throughout the device. The foam 60 is preferably white in color and translucent. However, not to mention that its manufacturing cost is relatively higher and it is difficult to make as its structure is more complicated, the optical fibers 24, and 24a are extremely easy to break or deform at those dotted locations since the surfaces there are damaged by the laser, thereby affecting its light emitting direction and optical efficiency.

Please refer to FIG. 3, which shows an optical fiber having a diffusion line, disclosed in U.S. Pat. No. 6,714,185, entitled “BACK LIGHTING APPARATUS OF LIQUID CRYSTAL DISPLAY USING OPTICAL FIBER”. As seen in FIG. 3, a diffusion line 621 is formed on the surface of an optical fiber 62 by a surface processing method for light scattering, which can be formed as a plurality of diffusion plates arranged lengthwise, spaced at a certain distance, along the optical fiber 62; or is continuous in the lengthwise direction of optical fiber 62; or can be composed of at least two longitudinal diffusion lines, arranged parallel to each other. Moreover, the diffusion line 621 can be formed by an etching method or a lithography method. In addition, the back lighting apparatus of a liquid crystal display apparatus using an optical fiber according to the present invention is capable of implementing a three-dimensional (3D) image by concurrently illuminating two pixel lines using one optical fiber having two diffusion lines. Nevertheless, if the diffusion line 621 is formed by an etching method, the surface of the optical fiber is damaged; and if it is formed by a lithography method, its precision is in question. Furthermore, as there is no reflective means being used for reflecting light beamed in each optical fiber out of its dotted hole, it can not provide satisfactory illumination, not to mentioned that the light is further being scattered by the diffusion line 621.

Please refer to FIG. 4, which shows an optical fiber having a plurality of successive notches with reflecting surface formed thereon, disclosed in U.S. Pat. No. 5,432,876, entitled “ILLUMINATION DEVICES AND OPTICAL FIBERS FOR USE THEREIN”. As seen in FIG. 4, an optical fiber 2 has successive notches 4 of a variety of shapes to divert and reflect a proportion of the light propagating through the fiber to emit light from the fiber 2 by the reflecting surfaces 4, 6 of each notch 4. However, as the aforesaid optical fiber 2 is also damaged by the successive notches 4, it can be easily broken right at the positions of those notches 4 when it is bended, thereby deforming the notches while affecting its light emitting direction and optical efficiency. In addition, not only it is difficult to form each notch 4 precisely at intended inclination angle and depth, but also the optical efficiency of the optical fiber 2 is low since each notch can reflect light only once.

From the above description, it is noted that the formation of microstructures on the surface of an optical fiber has the following shortcomings:
(1) The microstructures formed on the surface of an optical fiber are easily being damaged by normal usage as it is exposed to outside environment.
(2) As the surface of an optical fiber is usually required to be applied by adhesive, the microstructures formed on the surface are thus contaminated, affecting the optical characteristics thereof.
(3) The microstructures formed on the surface are easily to be snapped or deformed while the optical fiber is subjecting to an external force and bended.

Since all the aforesaid shortcomings will have adverse affect upon the side-emitting efficiency and uniformity of the optical fiber, it is in need of an improved optical fiber, that is free from the aforesaid shortcomings, for providing increased intensity of light at specific locations and uniformly distributed illumination throughout the device relative to the amount of light beamed in.

### SUMMARY OF THE INVENTION

In view of the disadvantages of prior art, the primary object of the present invention is to provide an optical fiber having a plurality of microstructures formed upon a core of the aforesaid optical fiber, by which not only the plural microstructures are prevented from being damaged by normal usage and contacting to adhesive directly, but also they can lower the risk of the optical fiber being snapped/deformed while the optical fiber is subjecting to an external force and bended.

It is another object of the invention to provide an optical fiber having three-dimensional microstructures formed therein, by which the light efficiency and the light uniformity of the optical fiber are improved.

Yet, another object of the invention is to provide an optical fiber manufacturing method, capable of producing flexible optical fibers suitable to be adapted for any curved surface.

Furthermore, another object of the invention is to provide a method for manufacturing optical fibers, capable of controlling and adjusting the brightness of an optical fiber produced thereby by controlling the shape, quantity, size, distribution density and locations of microstructures to be formed inside the optical fiber.

To achieve the above object, the present invention provides an optical fiber, comprising: a core, having a plurality of microstructures formed therein; and a cladding layer, surrounding the core; wherein, as light is propagating along the core of the aforesaid optical fiber and strikes on the plural microstructures, it is scattered and reflected out of the optical fiber through a side wall thereof so as to achieve a side-emitting effect.

To achieve the above object, the present invention further provides a side-emitting method for optical fibers, comprising the steps of: (a) optically connecting an end of an optical fiber having a plurality of microstructures formed therein to a light source so as to feed light of the light source into the optical fiber; and (b) defining the plural microstructures to be so-structured for disrupting the internal reflection of the optical fiber that as soon as the light traveling along its length hit on any one of the plural microstructures, the light is scattered and sideway emitted out of the optical fiber.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 shows a fiber optic light emitting panel, disclosed in U.S. Pat. No. 4,885,663.

FIG. 2 shows a cross section of a backlighting panel, disclosed in U.S. Pat. No. 5,226,105.

FIG. 3 shows an optical fiber having a diffusion line, disclosed in U.S. Pat. No. 6,714,185.

FIG. 4 shows an optical fiber having a plurality of successive notches with reflecting surface formed thereon, disclosed in U.S. Pat. No. 5,432,876.

FIG. 5 shows an optical fiber having a microstructure formed therein according to a preferred embodiment of the invention.

FIG. 5A shows an optical fiber having a plurality of microstructures formed therein according to a preferred embodiment of the invention.

FIG. 6 is a schematic diagram depicting a system used for forming microstructures in an optical fiber according to the present invention.

FIG. 6A(a) is a front view of a first test sample used in the invention.

FIG. 6A(b) is a side view of a first test sample used in the invention.

FIG. 6B(a) is a front view of a second test sample used in the invention.

FIG. 6B(b) is a side view of a second test sample used in the invention.

FIG. 7 is a schematic diagram illustrating a first method of forming a plurality of microstructures inside an optical fiber according to the present invention.

FIG. 8 is a schematic diagram illustrating three concentric circles of microstructures being formed inside an optical fiber by the first method of FIG. 7.

FIG. 9 is a schematic diagram illustrating two triangular arrays of microstructures being formed inside an optical fiber while arranging the two arrays to be symmetrical to the axis of the optical fiber by the first method of FIG. 7.

FIG. 10 is a schematic diagram illustrating a second method of forming a plurality of microstructures inside an optical fiber according to the present invention.

FIG. 11 is a schematic diagram illustrating two radial-distributed concentric circles of microstructures being formed inside an optical fiber by the second method of FIG. 10.

FIG. 12 is a schematic diagram illustrating a third method of forming a plurality of microstructures inside an optical fiber according to the present invention.

FIG. 13 is a schematic diagram depicting the formation of microstructures inside an optical fiber using a plurality of laser devices.

FIG. 14 is a schematic diagram showing a process integrating the formation of microstructures with the manufacturing of an optical fiber according to the present invention.

FIG. 15 is a schematic diagram showing an optical fiber structure composed of a plurality of optical fibers according to an embodiment of the present invention.

FIG. 16 is a schematic diagram showing an optical fiber structure composed of a plurality of optical fibers according to another embodiment of the present invention.

FIG. 17 is a schematic diagram showing an optical fiber structure of the invention, structured and used as a fiber optic backlighting panel.

FIG. 17A is an A-A cross section of FIG. 17.

FIG. 18 a schematic diagram showing an optical fiber structure of the invention, structured and used as a flexible illumination device.

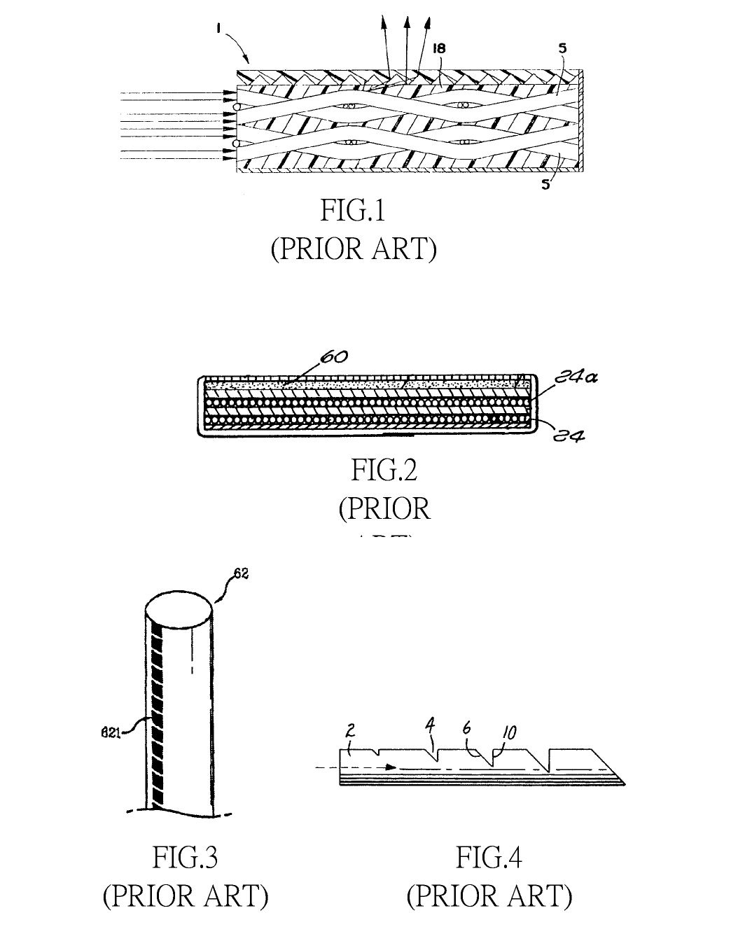

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

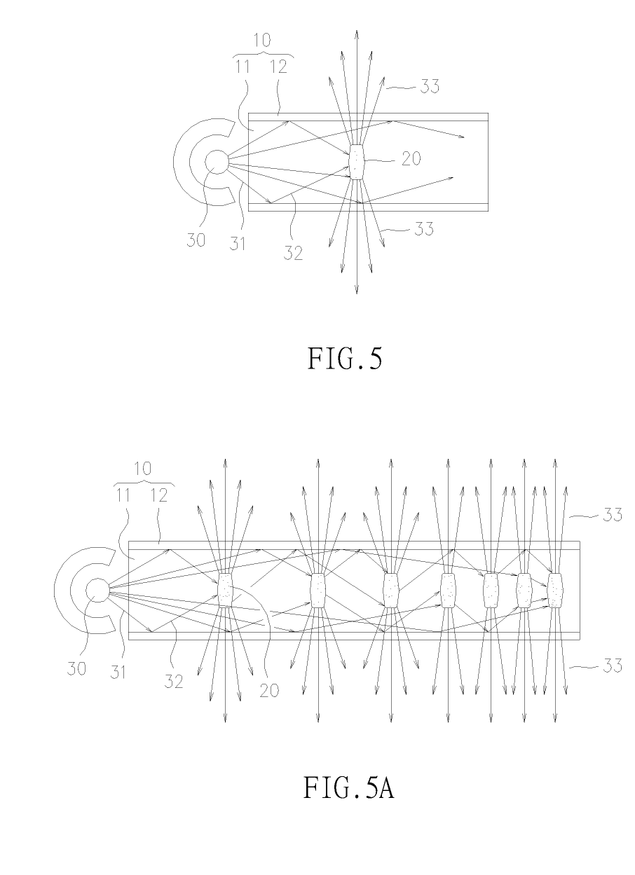

Please refer to FIG. 5, which shows an optical fiber having a microstructure formed therein according to a preferred embodiment of the invention. The purpose of forming the microstructure 20 inside the optical fiber 10 is to enable the optical fiber 10 to emit light radially from the side wall thereof. In FIG. 5, the optical fiber 10 is substantially composed of a core 11 wrapped by a cladding layer 12, that can be made of a transparent material, such as plastic, glass, quartz, etc., and can be cylindrical in shape, or other geometrical shapes at will. The microstructure 20 is arranged on the core 11 in a manner that the shape, quantity, size, distribution density and location are only dependent upon actual requirement and thus are not limited by any rule. Thus, there can be only one microstructure 20 formed on the core 11, as seen in FIG. 5, or there can be a plurality of microstructures 20, as seen in FIG. 5A. For a cylindrical-shaped optical fiber 10, the size of each microstructure 20 should be no larger than the diameter of the core 11, and preferably each microstructure 20 may be a structure of regular shape or a structure of irregular shape.

As seen in FIG. 5, an end of the optical fiber 10 is optically connected to a light source 30 for feeding the light 31 of the light source 30 into the optical fiber 10. As the light 30 is guided to travel along the length of the optical fiber 10 by total internal reflection, represented by the reflected light 32, and strikes on the microstructure 20, the light 31 as well as the reflected light 32 will be scattered and reflected out of the optical fiber through a side wall thereof so as to achieve a side-emitting effect since the scattered light 33 exceeds the critical angle for internal reflection. It is noted that the direction of the scattered light 33 being emitted radially out of the optical fiber 10 is dependent upon the three-dimension structure of the microstructure 20. Furthermore, as the further the light 31 is traveling inside the optical fiber 10, the weaker the brightness thereof will be since it is propagating by total internal reflection that will cause a certain amount of energy loss, it is preferred to formed the microstructure 20 basing on the following principle: the farther the positioning of the optical fiber is to the light source 30, the higher the density of the microstructure 20 will be formed thereon, thereby, the brightness of the scattered light 33 emitted from the farther area of the optical fiber 10 is enhanced. That is, by controlling the shape, quantity, size, distribution density and location of the microstructure 20, the brightness of the side-emitting optical fiber 10 can be adjusted correspondingly.

With the aforesaid optical fiber 10, a side-emitting method for optical fibers can be provided, which comprises the steps of:
(a) optically connecting an end of an optical fiber 10 having a plurality of microstructures 20 formed therein to a light source 30 so as to feed light 31 of the light source 30 into the optical fiber 10; and
(b) defining the plural microstructures 20 to be so-structured for disrupting the internal reflection of the optical fiber 10 that as soon as the light 30 traveling along the length of the optical fiber 10 hit on any one of the plural microstructures 20, the light 30 is scattered and sideway emitted out of the optical fiber 10.

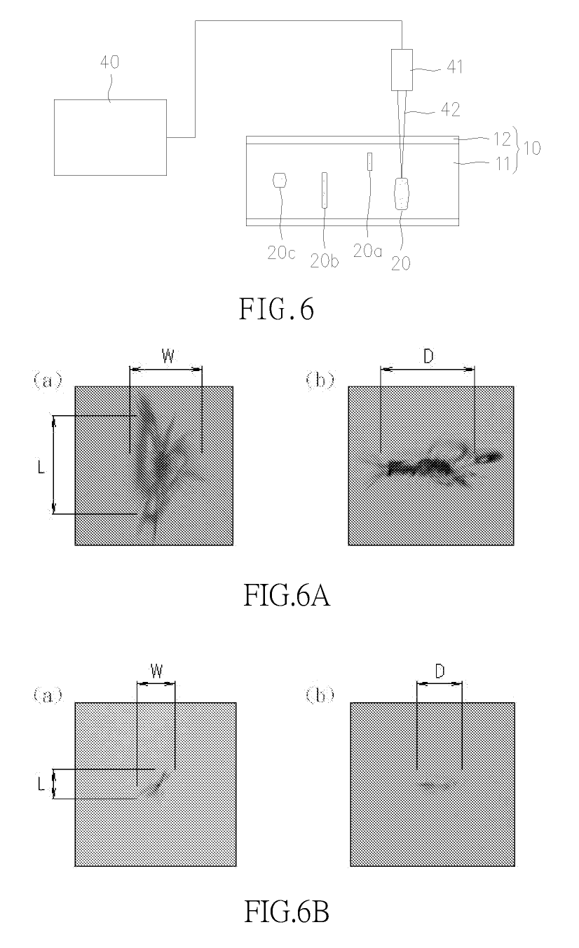

Please refer to FIG. 6, which is a schematic diagram depicting a system used for forming microstructures in an optical fiber according to the present invention. In FIG. 6, the system used for forming microstructures in an optical fiber 10 is a laser device 40, which can be a carbon dioxide laser device, a Nd-YAG laser device or an excimer laser device, etc., operating in a continuous or pulsed manner. The laser light 42 of the laser device 40 is focused to the interior of the optical fiber 10 by a lens set 41, i.e. onto the core 11 of the optical fiber 10. The sole purpose of the lens set 41 is to decide how the laser light 42 should be focused on the core and thus determine the size of the focal point being formed upon the core. It is noted that the size of the focal point will affect the size of the microstructure being formed on the core 11, as those microstructures 20, 20a, 20b and 20c, shown in FIG. 6, and the physical attributes of the microstructure 20, such as size, distribution density, and refraction index, etc., will all have affect upon the side-emitting brightness of the optical fiber 10. Since the forming of the microstructures 20 by the laser device 40 is a contactless processing method, the cladding layer 12 of the optical fiber 10 will not be damaged, thereby, not only the microstructures 20 are protected from exposing to outside environment, but also the adverse affection upon the strength of the optical fiber 10 by forming the microstructures 20 on the core 11 is minimized.

The shape of the microstructure being formed by a laser device is primarily determined on two factors, that the first is related to the laser pulse duration and laser wavelength while another is related to the selecting of lens set 41 used for matching the laser device 40. Technically, the forming of microstructure by a laser device is similar to laser engraving, however, the laser engraving technique is not seen being used for enabling an optical fiber to emit light from the side wall thereof. In an experiment of striking a 1064 nm laser light upon a sample glass through a lens set of F44 focal length, a pattern of about 100 μm˜250 μm in length L, 100 μm˜250 μm in width W, and about 100 μm˜200 μm in depth D, can be achieved, as those shown in FIG. 6(a) and FIG. 6(b) in respective. In another experiment of striking a 532 nm laser light upon a sample glass through a lens set of F22 focal length, a pattern of about 30 μm˜80 μm in length L, 30 μm˜80 μm in width W, and about 40 μm˜120 μm in depth D, can be achieved, as those shown in FIG. 6(a) and FIG. 6(b) in respective. Thus, it is evidenced that the dimension and depth of a microstructure being formed on the core of an optical fiber can actually be controlled by the selection of laser wavelength and the lens set.

Basing on the above system of forming microstructures on the core of an optical fiber, various manufacturing methods can be structured that can be used for achieving various microstructures of different distribution densities and styles.

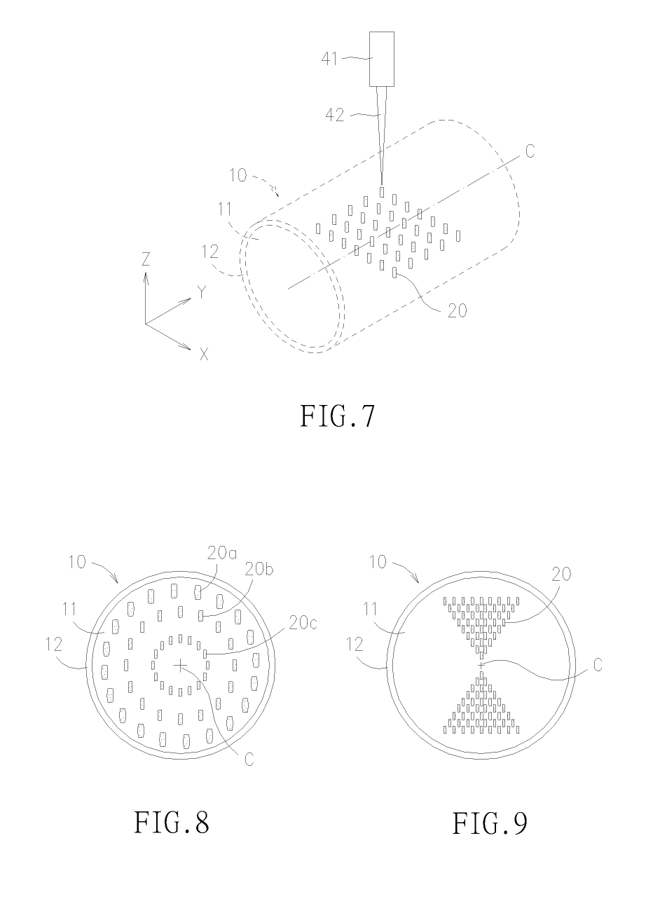

In FIG. 7, an optical fiber 10 is substantially a cylindrical-shaped thread having an axis C extending along a Y-axis direction defined by an Cartesian coordinate system of X-axis, Y-axis and Z-axis, and a lens set 41 is fixedly positioned above the optical fiber at a location defined by the Z-axis for direction a laser beam 42 to downward-focus upon the core 11 of the optical fiber 10 following a Z-axis direction while the lens set 41 is capable of being driven to perform a two-dimensional movement with respect to the X- and the Y-axis, thereby, a two-dimensional matrix of microstructures 20 can be formed on the core 11. Similarly, the two-dimensional matrix of microstructures 20 can be formed by fixed arranged the lens set 41 to a position without moving while enabling the optical fiber 10 to perform the two-dimensional movement. In another preferred embodiment, the lens set 41 is fixedly positioned at a position capable of directing the laser beam 42 to propagate along an Y-axis direction parallel to the axis C of the optical fiber 10 and focus upon the core 11 of the optical fiber 10, while either the optical fiber 10 or the lens set 41 is capable of being driven to perform a two-dimensional movement with respect to the X- and the Z-axis, thereby, an array of microstructures can be formed with respect to a specific cross section of the optical fiber 10. As seen in FIG. 8, there are three concentric circles of microstructures 20a˜20c of reducing size being formed on the core 11 of the optical fiber 10. Moreover, as seen in FIG. 9, there are two triangular arrays of microstructures 20 being formed inside an optical fiber while arranging the two arrays to be symmetrical to the axis C of the optical fiber 10.

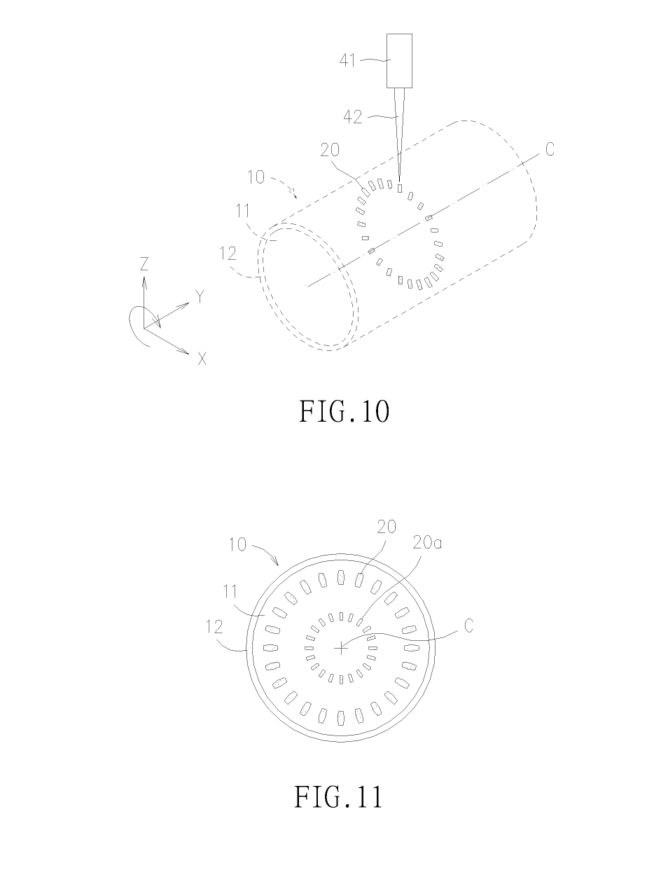

In FIG. 10, an optical fiber 10 is substantially a cylindrical-shaped thread having an axis C extending along a Y-axis direction defined by an Cartesian coordinate system of X-axis, Y-axis and Z-axis, and a lens set 41 is fixedly positioned above the optical fiber at a location defined by the Z-axis for direction a laser beam 42 to downward-focus upon the core 11 of the optical fiber 10 following a Z-axis direction while the optical fiber 10 is capable of being driven to rotate about its axis C, thereby, a plurality of microstructures 20 radially distributed around the axis C of the optical fiber 10 can be formed. In addition, by changing the focal point of the lens set 41, another ring of radial-distributed microstructures 20a of smaller size can be formed, as seen in FIG. 11. Similarly, such rings of microstructures 20, 20a can also be formed by fixedly arranged the optical fiber 10 to a position while enabling the lens set 41 to revolve around the optical fiber 10. It is noted that microstructures of different distributions and circular alignments can be achieved with respect to different manners that such microstructures are to be formed.

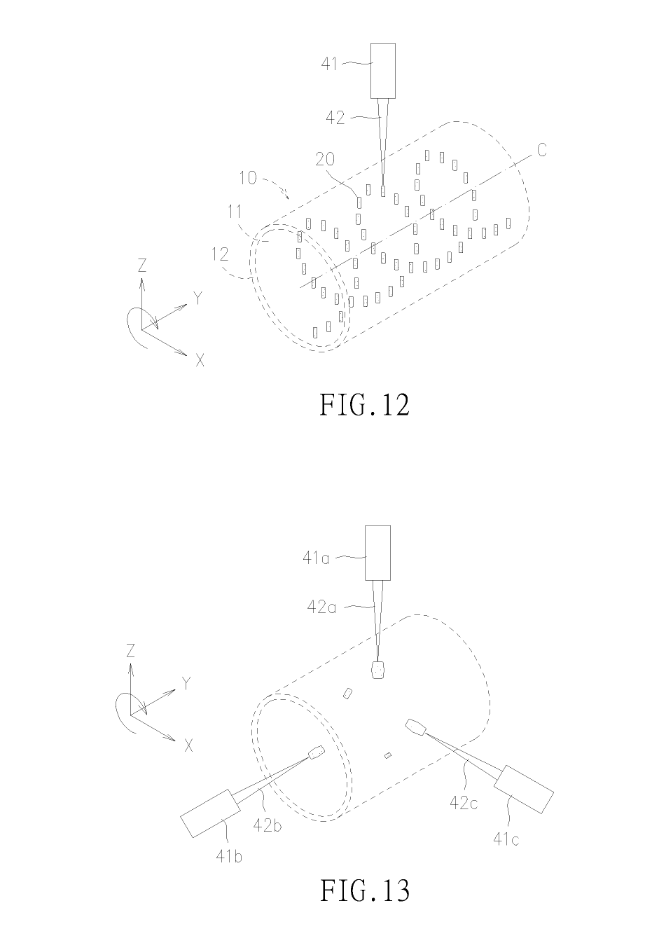

As seen in FIG. 12, the plural spiral-aligned microstructures 20 are formed by simultaneously driving the lens set 41 and/or the optical fiber 10 to move and/or rotate. Moreover, there can be more than one lens sets to be used for forming microstructures at the same time, as the three lens sets 41a, 41b and 41c shown in FIG. 13. The three lens sets 41a, 41b and 41c are used respectively for directing their corresponding laser beams to propagating along different direction and focus at different position on the core 11, and moreover, the three lens sets 41a, 41b and 41c can be control to operate in a synchronous manner or an asynchronous manner, thereby, microstructures 20a˜20c of different sizes can be achieved.

It is to be emphasized that no matter how the optical fiber 10 and the lens set 41 are to be activated, the corresponding laser beam is always being focused on the core 11 of the optical fiber 10 without causing any damage to its cladding layer 12.

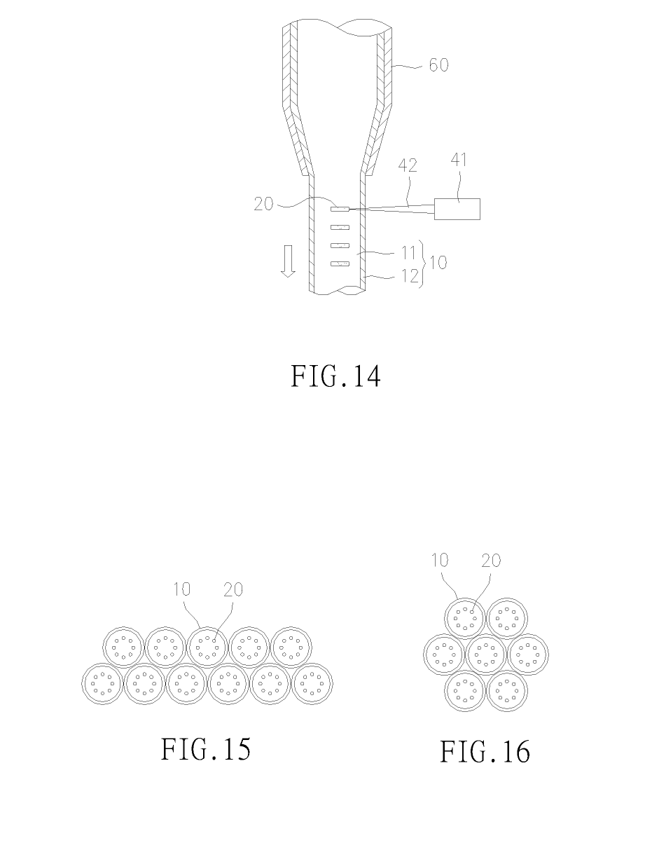

As the side-emitting effect of the optical fiber 10 disclosed in the present invention is achieve by the use of laser devices to form microstructures 20 on the core 11 of the optical fiber 10, the formation of the microstructures 20 on the corell of the optical fiber 10 can be performed after the manufacturing of the optical fiber 10 or during the manufacturing of the optical fiber 10 by integrating the process of forming microstructures 20 into the manufacturing process of the optical fiber 10, as seen in FIG. 14. In FIG. 14, as the optical fiber 10 is being pull out of a fiber drawing mold 60 while other required fiber drawing apparatuses are waived and not shown in the figure, the lens set 41 is positioned at a specific location adjacent to the fiber drawing mold 60 so as to focus laser beams onto the core 11 of the just-being-drawn optical fiber 10 for forming microstructures 20 thereon as soon as the optical fiber 10 emerges from the exit of the fiber drawing mold 60.

As seen in FIG. 15 and FIG. 16, an optical fiber structure composed of a plurality of optical fibers of the invention can be achieved for brightness enhancement. In FIG. 15, an optical fiber structure is substantially a stacking of two optic layers, each optical layer being composed of a plurality of parallel-arranged optical fibers 10 with microstructures 20 formed therein, by which the brightness of intended light-emitting surface of the optical fiber structure is improved. In FIG. 16, an optical fiber structure is substantially a bundle of optical fibers 20 having microstructures formed therein. It is noted the more such optical fibers 10 being bundled in the optical fiber structure of FIG. 16, the brighter the optical fiber structure will be, moreover, the plural optical fibers 10 can be weaved or twisted together, whichever is good for the brightness thereof.

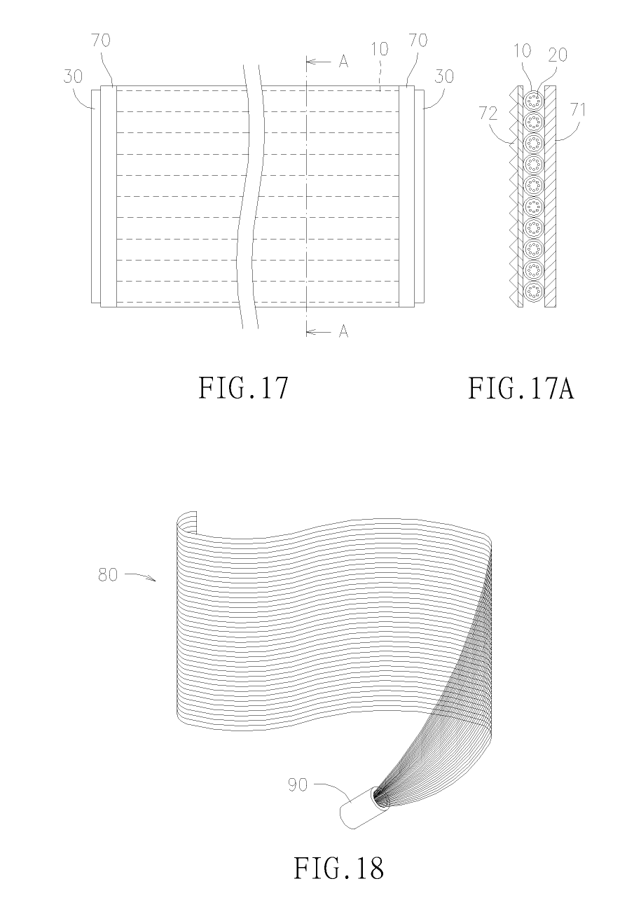

Please refer to FIG. 17 and FIG. 17A, which are respectively a schematic diagram showing an optical fiber structure of the invention, structured and used as a fiber optic backlighting panel, and a A-A cross sectional view thereof. In FIG. 17, a layer of optical fibers 10 are arranged adjacent to each other to be used as a fiber optic backlighting panel for transmitting the light beam therein to different locations throughout the panel, in which each optical fiber 10 has microstructures formed therein and is optically connected to a light source 30 by an end thereof while using a clapping device 70 to fixedly clip and align the end of the optical fiber 10 to the light source 30. The mechanism, appearance and operating method of the clapping device 70 is known to those skilled in the art and thus are not described further herein. The purpose of disposing the clapping device 70 is to enable the light of the light source 30 to be feed smoothly into and propagating throughout each optical fiber 10. Since the microstructures 20 formed inside each of the optical fiber 10 is so-structured that each is capable of disrupting the internal reflection of the optical fiber 10, the light propagating along the length of each optical fiber 10 is scattered and sideway emitted out of the optical fiber 10 when the it hit on any one of the microstructures 20, similar to that shown in FIG. 5. Thereby, the layer of optical fiber can be used as a fiber optic backlighting panel capable of transmitting the light beamed therein to different locations throughout the panel and thus providing increased and uniform intensity of light at specific locations or uniformly distributed light throughout the panel. Moreover, as the brightness of the fiber optic backlighting panel is achieved by the scattered light being emitted radially form the side wall of each optical fiber of the fiber optic backlighting panel, a reflective panel 71 and a brightness enhancement film 72 can be integrated into the fiber optic backlighting panel for brightness enhancement. As seen in FIG. 17A, the layer of optical fibers 10 is sandwiched between the reflective panel 71 and the brightness enhancement film 72, by which the scattered light emitted out of each optical fiber 10 can be reflected to shine on the brightness enhancement film 72 by the reflective panel 71 where they are being focused thereby and assembled within a specific range, and thus the brightness of the fiber optic backlighting panel is enhanced. In addition, for providing uniformly distributed light throughout the panel, the distribution of the microstructures 20 inside each optical fiber 10 of the fiber optic backlighting panel is controlled by a manner that the closer the positioning of the optical fiber 10 is to the light source 30, the lower the density of the microstructure 20 will be formed thereon, or the smaller the size of the microstructure 20 is; and vice versa. That is, by controlling the distribution density of the microstructure 20, the uniformity of the side-emitting optical fiber 10 can be controlled correspondingly, which is similar in principle as that illustrated in FIG. 5.

Please refer to FIG. 18, which is a schematic diagram showing an optical fiber structure of the invention, structured and used as a flexible illumination device. The flexible illumination device, capable of being bended and deformed, is composed of a plurality of optical fibers 10, being arranged adjacent to each other to form a flat panel while adhering to each other by an adhesive. Moreover, each optical fiber 10 has microstructures formed therein and every optical fiber 30 is optically connected to light sources by an end thereof while using a clapping device 90 to fixedly bundle all the ends of the optical fibers 10 to those light sources. The disposing of the clapping device 90 is to enable the light of those light sources to be feed smoothly into and propagating throughout each optical fiber 10. Since the microstructures 20 formed inside each of the optical fiber 10 is so-structured that each is capable of disrupting the internal reflection of the optical fiber 10, the light propagating along the length of each optical fiber 10 is scattered and sideway emitted out of the optical fiber 10 when the it hit on any one of the microstructures 20, thereby, the illumination device is able to provide uniformly distributed light throughout the device. Similar to that illustrated in FIG. 17, for providing uniformly distributed light throughout the flexible illumination device, the distribution of the microstructures 20 inside each optical fiber 10 of the flexible illumination device is controlled by a manner that the closer the positioning of the optical fiber 10 is to the clapping device 90, the lower the density of the microstructure 20 will be formed thereon, or the smaller the size of the microstructure 20 is; and vice versa. That is, by controlling the distribution density of the microstructure 20, the uniformity of the side-emitting optical fiber 10 can be controlled correspondingly, which is also similar in principle as that illustrated in FIG. 5.

To sum up, different form those conventional method of forming microstructures on the surface of optical fibers, the present invention provides an optical fiber having a plurality of microstructures formed upon a core of the aforesaid optical fiber by a laser device, by which not only the plural microstructures are prevented from being damaged by normal usage and contacting to adhesive directly, but also they can lower the risk of the optical fiber being snapped/deformed while the optical fiber is subjecting to an external force and bended. An optical fiber is disclosed, which is comprised of: a core, having a plurality of microstructures formed thereon; and a cladding layer, surrounding the core. In a preferred embodiment, as light is transmitting along the axis of the aforesaid optical fiber and strikes on the plural microstructures, it is scattered and reflected out of the optical fiber through a side wall thereof so as to achieve a side-emitting effect. As the microstructures are formed inside the core of the aforesaid optical fiber, not only they are prevented from being damaged by normal usage, contacting to adhesive directly, but also they can lower the risk of the optical fiber being snapped/deformed while the optical fiber is subjecting to an external force and bended. In addition, by controlling the shape, quantity, size, distribution density and location of the microstructure, the brightness of the side-emitting optical fiber can be adjusted correspondingly.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An optical fiber, comprising:
a core, having at least a microstructure formed thereon; and
a cladding layer, surrounding the core.

2. The optical fiber of claim 1, wherein the at least one microstructure is a three-dimension (3D) structure.

3. The optical fiber of claim 1, wherein the microstructure is structured as an array selected from the group consisting of a one-dimensional array, a multi-dimensional array.

4. The optical fiber of claim 1, wherein there is a plurality of the microstructures of different sizes, or the same size formed on the core.

5. The optical fiber of claim 1, being made of a transparent material selected from the group consisting of plastic, glass, quartz, and the like.

6. A method for manufacturing optical fibers, comprising the steps of:
(a) providing an optical fiber composed of a core and a cladding layer wrapping the core; and
(b) processing and forming at least a microstructure on the core.

7. The method of claim 6, wherein the at least one microstructure is formed by the use of at least a laser device.

8. The method of claim 7, wherein each laser device is comprised of a lens set, being used for focusing laser beams of the laser device onto the core.

9. The method of claim 7, wherein the laser device is a device selected from the group consisting of a continuous carbon dioxide laser device, a pulsed carbon dioxide laser device, a Nd-YAG laser device and an excimer laser device.

10. The method of claim 7, wherein the laser device can be driven to perform a motion selected form the group consisting of a one-dimensional movement, a one-dimensional rotation, a multi-dimensional movement, and a multi-dimensional rotation.

11. The method of claim 7, wherein there is a plurality of the laser device being used for forming the at least one microstructure.

12. The method of claim 11, wherein the emitting direction of each one of the plural laser devices is different from each other.

13. The method of claim 11, wherein each one of the plural laser devices can be driven to perform a motion selected form the group consisting of a one-dimensional movement, a one-dimensional rotation, a multi-dimensional movement, and a multi-dimensional rotation.

14. The method of claim 6, wherein the processing and forming of the at least one microstructure is performed by a contactless processing means.

15. The method of claim 6, wherein the at least one microstructure is a three-dimension (3D) structure.

16. The method of claim 6, wherein the microstructure is structured as an array selected from the group consisting of a one-dimensional array, a multi-dimensional array.

17. The method of claim 6, wherein there is a plurality of the microstructures of different sizes, or the same size formed on the core.

18. The method of claim 6, wherein the optical fiber can be driven to perform a motion selected form the group consisting of a one-dimensional movement, a one-dimensional rotation, a multi-dimensional movement, and a multi-dimensional rotation.

19. The method of claim 6, wherein the optical fiber is made of a transparent material selected from the group consisting of plastic, glass, quartz, and the like.

20. An illumination device using optical fibers, comprising:
at least an optical fiber, each being composed of a core and a cladding layer wrapping the core;
at least a microstructure, formed on the core;
at least a light source, optically connected to an end of each optical fiber.

21. The illumination device of claim 20, wherein the at least one microstructure is a three-dimension (3D) structure.

22. The illumination device of claim 20, wherein the microstructure is structured as an array selected from the group consisting of a one-dimensional array, a multi-dimensional array.

23. The illumination device of claim 20, wherein there is a plurality of the microstructures of different sizes, or the same size formed on the core.

24. The illumination device of claim 20, wherein the size of each microstructure is not larger than that of the core.

25. The illumination device of claim 20, wherein the at least one optical fiber is made of a transparent material selected from the group consisting of plastic, glass, quartz, and the like.

26. The illumination device of claim 20, wherein the closer the positioning of the optical fiber is to the at least one light source, the lower the density of the microstructure will be formed thereon, or the smaller the size of the microstructure is.

27. The illumination device of claim 20, further comprising:
a clapping device, for fixedly clipping at least an end of the at least one optical fiber.

28. The illumination device of claim 20, further comprising:
a reflective panel, for reflecting light; and
a brightness enhancement film, disposed at a position enabling the at least one optical fiber to be sandwiched between the brightness enhancement film and the reflective panel, being used for focusing light within a specific range.
